(19) United States
(12) Patent Application Publication
(10) Pub. No.: US 2004/0123270 A1
(43) Pub. Date: Jun. 24, 2004

(54) Method and apparatus for shared libraries on mobile devices

(75) Inventors: Ruiqiang Zhuang, Plantation, FL (US); Jyh-Han Lin, Coral Springs, FL (US); Biren Patel, Sunrise, FL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/328,463

(22) Filed: Dec. 23, 2002

(51) Int. Cl. G06F 7/00

(52) U.S. Cl. 717/118

(57) ABSTRACT

A shared library architecture (iJDL) for sharing libraries among applications. The iJDLs can be added, removed, updated or directly retrieved from the network, and are fully configurable to maximize the usage of limited flash memory space. The iJDL model conforms to the standard sandbox security model defined by the MIDP 1.0 specification. A Java Application Manager (JAM) also may be provided to alert the user of any update to shared libraries available on the network. For security, iJDL can be authenticated such that only authorized vendors are allowed to use it.

### FIELD OF THE INVENTION

The present invention relates generally to Java libraries and, more particularly, to sharing Java libraries among applications on memory-limited Java devices.

### BACKGROUND OF THE INVENTION

The Java platform, developed by Sun Microsystems, Inc. of Santa Clara, Calif., (SUN) enables the same software to run on many different kinds of computers, consumer electronics and other devices. An advantage of Java is the ability of Java-technology based software to work on any kind of device that supports the Java platform.

A particular feature of the Java platform is the availability of a Java runtime environment for mobile devices, such as cellular telephones, including iDEN phones available from Motorola, Inc. of Schaumburg, Ill. This environment is known as the Mobile Information Device Profile (MIDP) and provides the core application functionality required by the mobile devices.

Limitations in MIDP of current installation and class loading model in high-volume mobile Java devices exist. For example, as shown in FIG. 1, in the current model there is a centralized romized class library 10 that is shared by all applications 12, 12′, 12″, 12′″, etc. There is, however, no class sharing between the applications themselves. This is a so-called “sandbox security model”, as defined by the MIDP 1.0 specification. Thus, a first limitation of this architecture is that the Romized class library cannot be updated unless the firmware is updated. This results in losing all installed applications. Second, applications are able to package their own libraries in a Java Archive (jar) file, which results in a possible duplication of class libraries. That is, each application has its own set of class libraries, even though the libraries may be identical. For memory-limited devices, such as mobile phones and the like, this is not efficient.

### BRIEF DESCRIPTION OF THE DRAWINGS

FIG. 1 is a block diagram of a prior art Java Romized class library;

FIG. 2 is a block diagram of a Java Romized class library having iJDLs in accordance with the present invention;

FIG. 3 is a flow diagram of class loading with iJDL support in accordance with the present invention; and

FIG. 4 is a continuation of the flow diagram of class loading with iJDL support of FIG. 3 in accordance with the present invention.

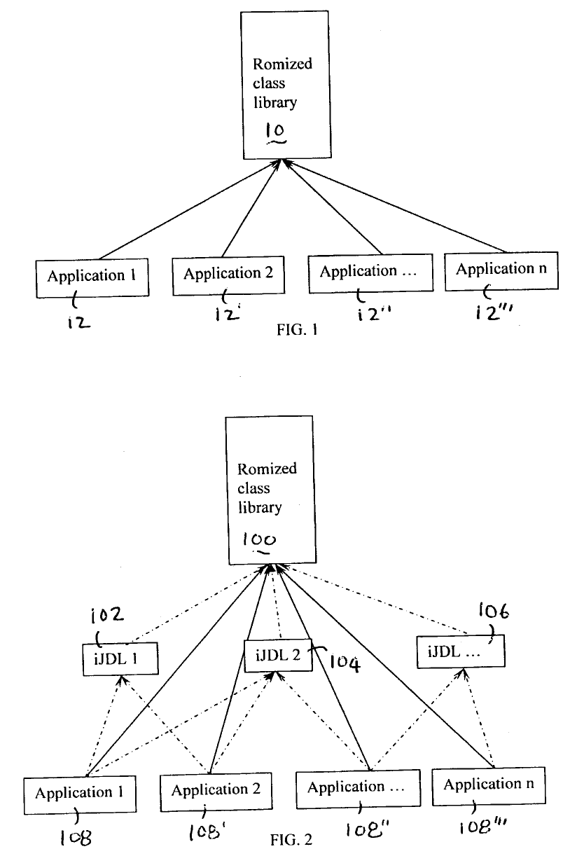

### DESCRIPTION

To address the need for efficient sharing of libraries among applications, there is provided a new shared library architecture, hereinafter referred to as iDEN Java Dynamic Library (iJDL). iJDLs have several advantages. For example, iJDLs may be shared among applications, can be added, removed, updated or directly retrieved from the network, and are fully configurable to maximize the usage of limited flash memory space. Advantageously, the iJDL model still conforms to the standard sandbox security model defined by the MIDP 1.0 specification propounded by Sun.

A Java Application Manager (JAM) also may be provided to alert the user of any update to shared libraries available on the network. The actual update is automatically performed after the user's confirmation is received. For security, use of the iJDL can be authenticated such that only authorized vendors are allowed to use it.

As shown in FIG. 2, the iJDL model also uses a class library loaded in a memory (Romized) 100, such as a flash type memory. The iJDLs 102, 104, 106 provide an interface between the applications, 108, 108′, 108″, 108′″. The applications are able to share class libraries, resulting in savings of limited flash memory space.

Each iJDL 102, 104, 106 has a descriptor file (.jdl) and a jar file (.jar). The format of iJDL descriptor file is defined as follows:

Mandatory attributes:

| | |
|---|---|
| iJDL-Name: | /* friendly name of the iJDL */ |
| iJDL-Vendor: | /* vendor name*/ |
| iJDL-Version: | /* version number (xx.xx.xx) */ |
| iJDL-Jar-Size: | /* size of the iJDL package */ |
| iJDL-Jar-URL: | /* location of the iJDL package */ |
| iJDL-1: | /* class path */ |
| iJDL-2: | /* class path */ |
| ... | |

| | |
|---|---|
| iJDL-n: | /* class path */ |
| MicroEdition-Configuration: | /* CLDC-1.0 */ |
| MicroEdition-Profile: | /* MIDP-1.0 */ |

Class path can be a file in .jar, or a universal resource locator (URL).

Optional attributes include:

| | |
|---|---|
| iJDL-description: | /* description of the iJDL */ |
| iJDL-authorization: | /* criteria of application which can use the iJDL |
| */ | |

For the authorization, the application's vendor name is used to determine whether an application can use the iJDL. For example, *—do not care vendors, any application can use it; and *Motorola*—vendor name must contain “Motorola”. The iJDL package is in standard .jar format and MANIFEST.MF is not required. To further enhance security, the iJDL descriptor file can be signed.

Java systems provide a way to add/remove/update iJDLs. For example, when adding/removing/updating, the iJDL checks all applications that may use this iJDL and notifies the user accordingly. Retrieving classes from the network is session based and can be cached for later usage. The class loader may set up a persistent and secure HTTPS connection for library retrieval from trusted web sites.

For applications that use iJDL, in the application descriptor file an additional new attribute, iJDL-path, is added. This specifies the particular iJDL(s) to use and its version number. Multiple iJDL's also can be specified. For example:

iJDL-path-1: xxx1.jdl, version number

iJDL-path-2: xxx2.jdl, version number

. . .

iJDL-path-n: xxxn.jdl, version number;

where version number is used to check against the version of iJDL. If a mismatch occurs, the application manager notifies the user accordingly.

Applications access classes in iJDL through a Class.forName( ) method, which has several advantages over known class access methods. For example, iJDL is not required for compiling and packaging application and updating iJDL does not require a recompile and redistribute application. Furthermore, as long as iJDL keeps the same interface, implementation details can be updated without modifying or re-installing the application. Also, an application can be installed without loading iJDL classes. As such, iJDL classes are loaded only when they are used, in a truly dynamic fashion. Advantageously, applications still run and perform correctly without iJDL support, if necessary, by packaging libraries in the .jar file.

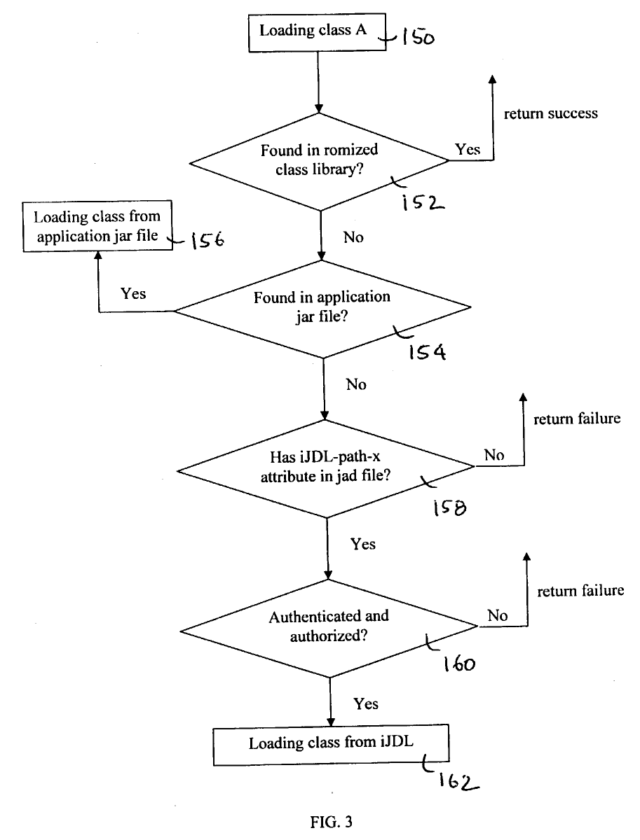

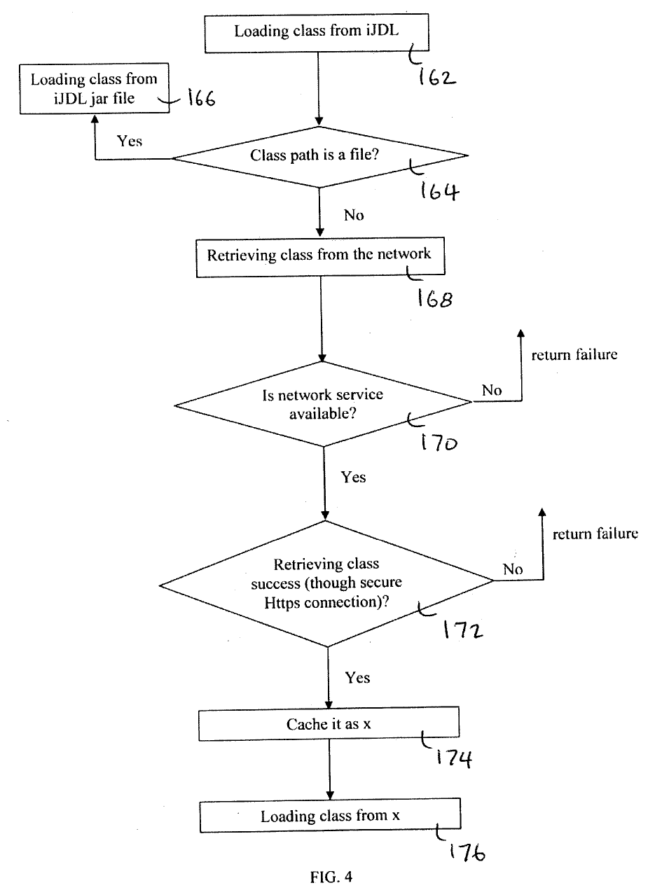

FIG. 3 illustrates the class loading procedure with iJDL support. In step 150, loading of class A, for example, is initiated. If the class is found in the Romized class library in step 152 then the process exits and returns a success message. Otherwise, in step 154, the process determines whether the class is in the .jar file. If so, then in step 156 the class is loaded from the application .jar file.

If the class was not found in the .jar file, then the .jad file is checked in step 158 to determine whether it has the iJDL-path-x attribute. If the iJDL-path-x attribute is not found in the .jad file, then the process exits with a failure message. However, if the iJDL-path-x attribute is found, then in step 160, the process checks to see whether the class path has been authenticated and is authorized. If not, the process exits with a failure message.

If the class path has been authenticated and is authorized, then the process for loading the class from the iJDL is initiated in step 162. In step 164 the process determines whether the class path is a file. If so, then the class is loaded from the iJDL .jar file in step 166. Otherwise, in step 168 the class is retrieved from the network.

In step 170, when attempting to retrieve the class from the network, the process determines whether network service is available. If service is unavailable, then the process exits with a failure message. Otherwise, in step 172 the system determines whether the class was retrieved successfully from the network, preferably through a secure hypertext transfer protocol (HTTPS) connection. If not, then the process exits with a failure message. If, however, the class was retrieved successfully, then it is cached as a particular name “x” in step 174 and the class is loaded from “x” in step 176.

It should be understood that the implementation of other variations and modifications of the invention in its various aspects will be apparent to those of ordinary skill in the art, and that the invention is not limited by the specific embodiments described. It is therefore contemplated to cover by the present invention, any and all modifications, variations, or equivalents that fall within the spirit and scope of the basic underlying principles disclosed and claimed herein.

What is claimed is:

1. A shared-library architecture, comprising:
a class library stored in a memory;
a plurality of applications configured to access the class library; and
a plurality of dynamic libraries configured to enable the plurality of applications to share access to a plurality of class libraries.

2. The shared library architecture of claim 1, further comprising an application manager for indicating the availability of an updated shared class library.

3. The shared library architecture of claim 2, further comprising a tag for indicating to the application manager the location of the updated shared class library.

4. The shared library architecture of claim 3, wherein the tag comprises a universal resource locator.

5. The shared library architecture of claim 1, wherein the dynamic library comprises a descriptor file and an archive file.

6. The shared library architecture of claim 5, wherein the dynamic library comprises:
a friendly name of the dynamic library;
a vendor name;
a version number of the dynamic library;
a size of the dynamic library package;
a location of the dynamic library package;
a class path;
a configuration file; and
a profile file.

7. The shared library architecture of claim 6, further comprising a description of the dynamic library;

8. The shared library architecture of claim 6, further comprising an authorization attribute for determining whether an application is allowed to use the dynamic library.

9. The shared library architecture of claim 6, further comprising a dynamic library path attribute for specifying the identity and version number of the dynamic library that is to be used.

10. In a Java compatible device, a class loading method comprising the steps of:
determining whether a predetermined class is loaded in a memory of the Java compatible device;
determining whether a class path attribute of the class is present;
determining whether the class path has been authenticated and is authorized; and
loading the class from the dynamic library.

11. The class loading method of claim 10, wherein the step of determining whether a class path attribute of the class is present further comprises the step of determining whether the class path attribute is located within a .jad file.

12. The class loading method of claim 10, wherein the loading step further comprises the step of loading the class from a .jar file upon determining the class path is a file.

13. The class loading method of claim 10, wherein the loading step further comprises the step of loading the class from a network upon determining the class path is not located within a .jar file.

14. The class loading method of claim 13, wherein a secure hypertext transfer protocol (HTTPS) connection is employed for accessing the network to obtain the class file.
